(19) United States
(12) Patent Application Publication
(10) Pub. No.: US 2013/0211558 A1
(43) Pub. Date: Aug. 15, 2013

(54) Suspension of Processes in Industrial Control System When an Anomaly Occurs

(71) Applicants: Takuya Mishina, Kanagawa (JP); John Wilson, Houston, TX (US)

(72) Inventors: Takuya Mishina, Kanagawa (JP); John Wilson, Houston, TX (US)

(73) Assignee: INTERNATIONAL BUSINESS MACHINES CORPORATION, Armonk, NY (US)

(21) Appl. No.: 13/606,615

(22) Filed: Sep. 7, 2012

Related U.S. Application Data
(63) Continuation of application No. 13/371,511, filed on Feb. 13, 2012.

(51) Int. Cl. G05B 9/02

(52) U.S. Cl. 700/79

(57) ABSTRACT

A method for suspension of processes in an industrial control system includes detecting at least one anomaly in an industrial control system; notifying a controller of the at least one anomaly; accessing a database comprising emergency suspend procedures; sending a stream comprising at least one emergency suspend command through at least one firewall/gateway to at least one downstream zone; and terminating or suspending a process in the at least one zone.

This application is a continuation application of U.S. Ser. No. 13/371,511 filed on Feb. 13, 2012 in the U.S. Patent and Trademark Office, the entirety of which is incorporated herein by reference.

### BACKGROUND

The present invention relates to an industrial control system, more particularly, to a system and methods for suspension of processes in industrial control systems when an anomaly occurs.

Industrial control systems (ICS), such as SCADA (supervisory control and data acquisition), monitor and control industrial or infrastructure facilities (e.g., oil and gas, refining, chemical, pharmaceutical, food and beverage, water and wastewater, pulp and paper, utility power, mining, metals, manufacturing facilities, etc.). Little concern has been given to the security in ICS because they have been isolated from the internet. However, more and more ICS are being interconnected to each other or connected to IT networks to control facilities smarter. Therefore, attacks on an ICS have now become a real issue, especially in light of examples of real attacks like the “Stuxnet” malware or the examples of other attacks like the Utilities in Brazil and the like.

In contrast to IT networks, ICS have some unique features as follows:

1. They may threaten human lives when they do not terminate in a predefined safety manner.
2. They often contain a number of devices in multiple zones dependent on each other.
3. They usually have a more stable or fixed configuration.
4. They cannot depend on the commercial strategy to defend only against known malware (black list approach). That is, they cannot afford an initial attack by an unknown piece of malware.
5. It is generally held that it is not possible to stop all intrusions into an ICS. Further, it will be likely that a target ICS will be unaware that it is infected. The first knowledge of infection may be when an attack begins to execute.

With reference to FIG. 1, a known ICS 100 comprises an ICS controller 105, at least one subcontroller 110, with each subcontroller associated with or in communication with a respective zone 115. Each zone 115 may be directly or indirectly connected to Input/Output devices 120, such as sensors and/or actuators, or may have another subcontroller 125 to which such I/O devices are connected.

There remains a need to enhance an ICS to include the ability to detect an anomaly and then deliver a set of suspend, hold, or termination commands to devices controlling processes in at least one zone.

### BRIEF SUMMARY

According to one or more embodiments of the present invention, a method for suspension of processes in an industrial control system is provided. At least one anomaly in an industrial control system is detected. A controller is notified of the at least one anomaly. A database comprising emergency procedures is accessed. A stream comprising at least one emergency command is sent through at least one firewall/gateway to at least one downstream zone. A process in the at least one zone is suspended or terminated.

According to another embodiment of the present invention, a method for suspension of processes in an industrial control system is provided. At least one anomaly in an industrial control system is detected. A controller is notified of the at least one anomaly. A read-only database comprising emergency procedures is accessed. A stream comprising at least one emergency command is sent through at least one firewall/gateway to a plurality of zones, each zone in communication with at least one input/output device. At least one process is suspended or terminated in a predetermined order for the plurality of zones.

According to one or more embodiments of the present invention, a system for suspension of processes in an industrial control system is provided comprising an industrial system comprising at least one controller and at least one zone, the at least one zone in communication with at least one input/output device; a protector system independent of the industrial control system and comprising at least one firewall/gateway; and a switch in communication with at least one of the at least one controller, the at least one input/output device, or the at least one firewall/gateway.

According to another embodiment of the present invention, a computer program product for suspension of processes in an industrial control system is provided comprising a computer readable storage medium. First program instructions detect at least one anomaly in an industrial control system. Second program instructions notify a controller of the at least one anomaly. Third program instructions access a database comprising emergency procedures. Fourth program instructions send a stream comprising at least one emergency command through at least one firewall/gateway to at least one downstream zone. Fifth program instructions suspend or terminate a process in the at least one zone. The first, second, third, fourth, and fifth program instructions are stored on the computer readable storage medium.

### BRIEF DESCRIPTION OF SEVERAL VIEWS OF THE DRAWINGS

FIG. 1 is a schematic diagram of a known industrial control system (ICS).

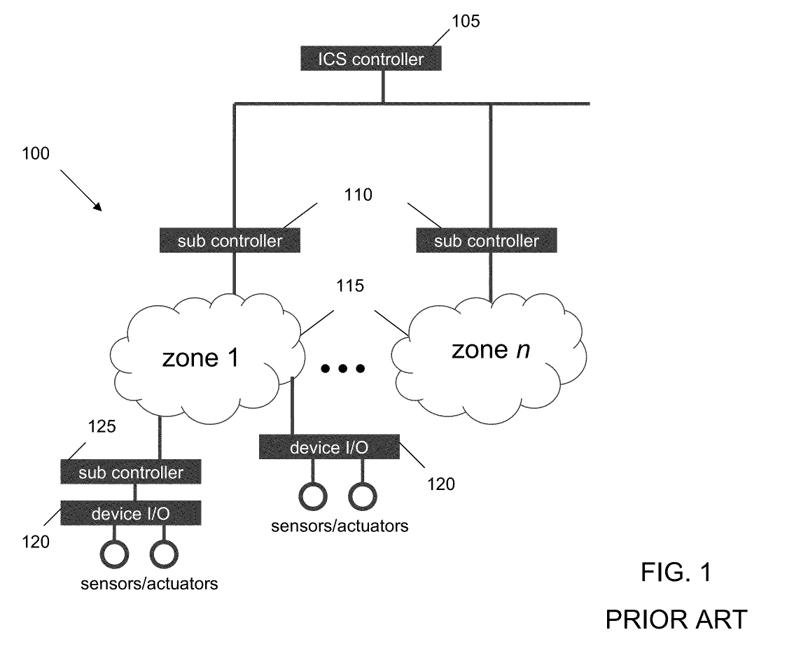

FIG. 2 is a schematic diagram of an ICS with an independent protection system.

FIG. 3 is a schematic diagram of an ICS with a switch in communication with a firewall/gateway of a protection system according to an embodiment of the present invention.

FIG. 4 is a schematic diagram of an emergency procedures database in communication with a firewall/gateway of a protection system.

FIG. 5 is a flowchart of a method according to an embodiment of the present invention.

FIG. 6 is a schematic diagram of a system according to an embodiment of the present invention.

### DETAILED DESCRIPTION

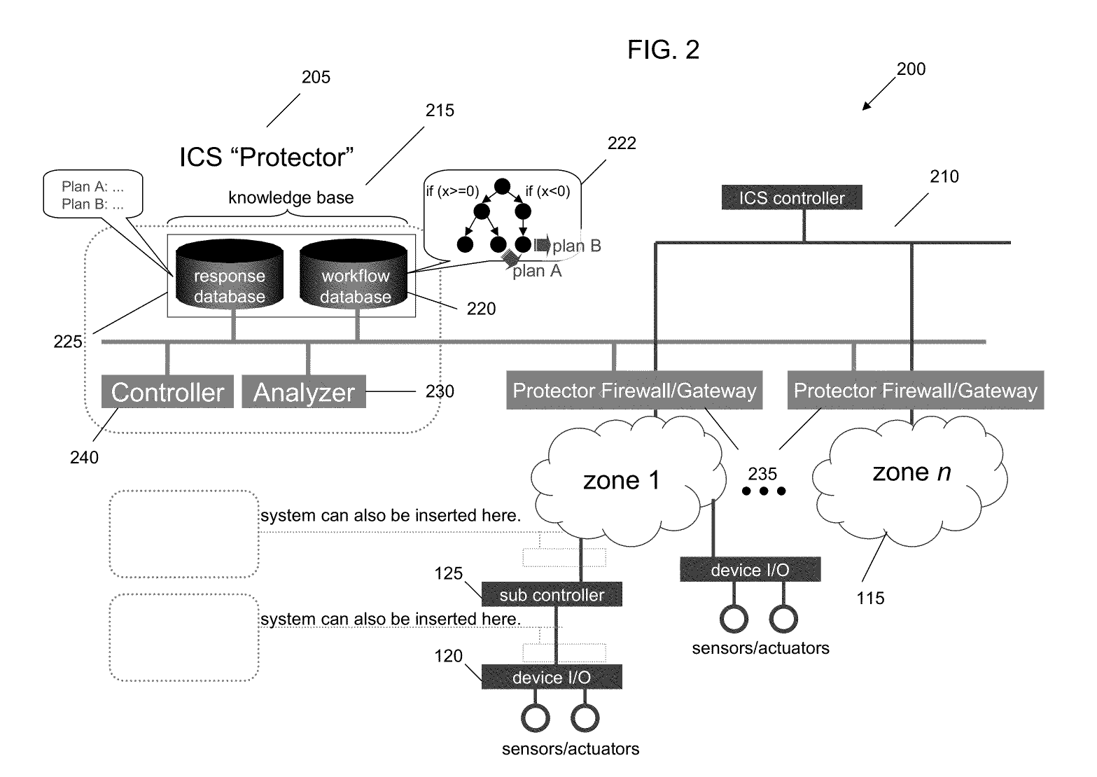

With reference now to FIG. 2, a schematic diagram of an ICS with a protection system or network is illustrated. An architecture 200 that detects specific situations of industrial control systems and performs appropriate actions at each situation includes a protection network 205 (ICS Protector and at least one firewall/gateway) independent of ICS network 210.

The protection network 205 includes a knowledge base 215 containing enhanced workflow data and cure plans not only for anomalies, but also for unanticipated disruptions in the work flow. A workflow database 220 comprises enhanced workflow data which comprises a normal workflow tree 222 with conditions. A response database 225 comprises cure plans not only for at least one anomaly, but also for any situation where the workflow is disturbed.

The independent protection network 205 also comprises an event analyzer 230. The event analyzer 230 may detect at least one event that triggers an appropriate cure or plan action based on data from at least one firewall/gateway 235 (e.g., a micro firewall) and from knowledge from the knowledge base 215.

The independent protection network 205 also comprises a controller 240, which receives reports from the event analyzer 230 and directs specific reactions given by the event analyzer 230 to at least one firewall/gateway 235. In specific embodiments, the controller 240 may direct reactions given by the event analyzer 230 to a plurality of firewall/gateways 235 simultaneously.

As shown in FIG. 2, the at least one firewall/gateway 235 of the protection network may be installed at an entry point of the at least one zone 115. The at least one firewall/gateway 235 monitors and controls inbound and outbound data flow, reports to the event analyzer 230, and is capable of directing operations to devices 120 in each zone based on the direction given by controller 240. In additional embodiments, the independent protection network 205 may be inserted between at least on zone 115 and a subcontroller 125 or between a subcontroller 125 and I/O devices 120.

If the ICS 210 is discovered to be under attack, a first response may be to place the I/O devices (for example, sensors, actuators, circuits, valves, breakers, pumps, heaters, coolers, regulators, modems, lights, conveyors, computers, etc.) in a suspend, hold, or termination mode in an orderly fashion and a proper sequence across at least one zone 115, for example, all existing zones. Thus, when the independent protection network 205 detects an anomaly in the ICS event stream, it may take over and deliver appropriate suspend, hold, or termination commands across at least one zone 115 and immediately alert plant operations staff. In a specific embodiment, the at least one firewall/gateway 235 may be instructed to ignore ICS commands and pass through commands from the protection network 205, whose purpose would be to shut down, terminate, or suspend processes in a predetermined ordered sequence.

The predetermined ordered sequence may be different depending upon the configuration of the industrial control system and/or infrastructure facility and the configuration of input/out put devices in the facility. For example, in a specific embodiment, instead of removing heat from a reaction vessel first and then pumping out the contents, the ordered sequence may comprise keeping the vessel contents at the proper temperature to insure proper viscosity, then pumping the vessel clear and turning off a heater. In another embodiment, the ordered sequence may comprise shutting off a feedstock pump in a cracking unit before shutting off the feed to a condenser or a sidecut stripper, and then shutting down the distillation column when the temperature and pressure are at appropriate levels. In some facilities, it may be desirable that the last device to be shut off is a ventilation system.

However, there may be scenarios in which there is no capability to receive and pass through suspend, hold, or termination commands to the at least one zone. For example, a plant architecture may not include an independent protection network and/or the ICS may behave in an anomalous fashion. Alternatively, a protector system or network itself may be under a security attack.

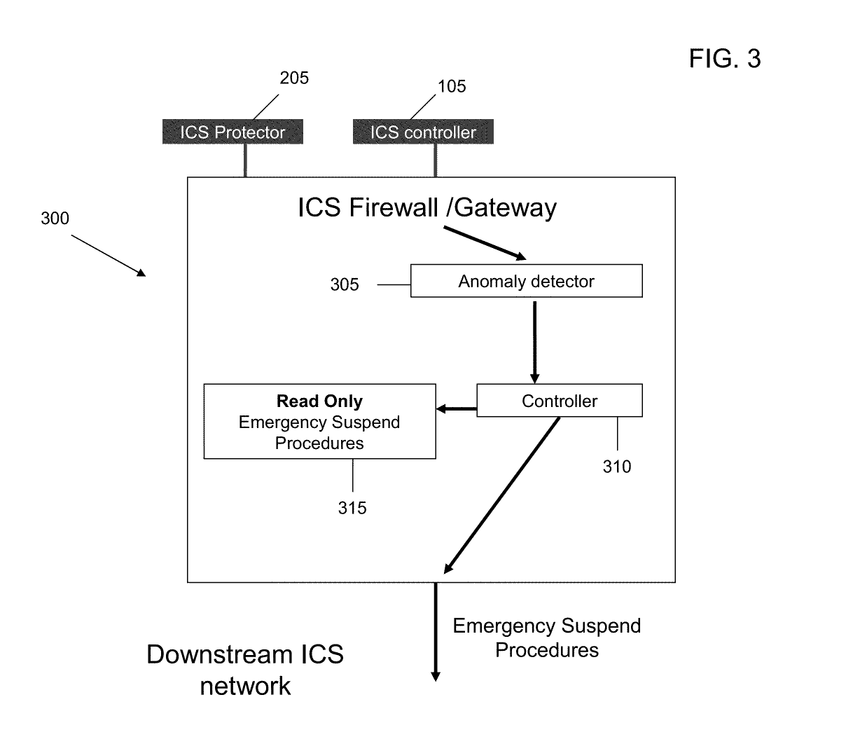

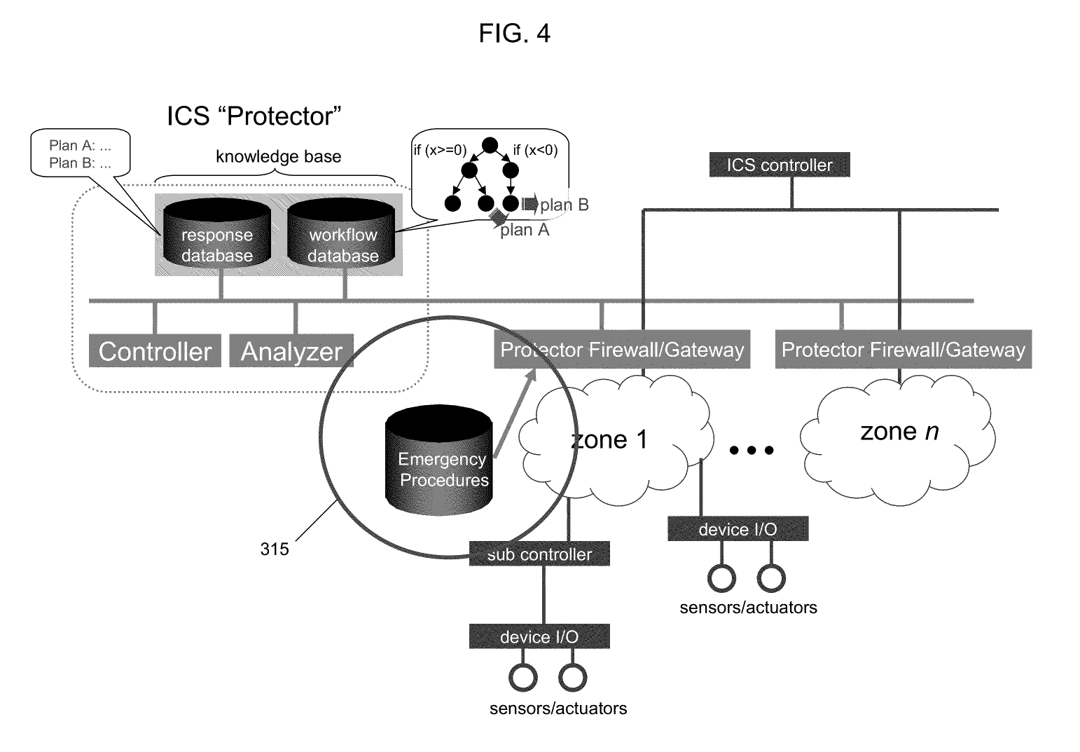

With reference now to FIGS. 3-4, according to an embodiment of the present invention, an ICS architecture may include a switch 300 (a “dead man” switch). As illustrated in FIG. 3, the switch 300 may be in communication with the at least one ICS firewall/gateway 235. However, in other embodiments, the switch 300 may be in communication with at least one controller 105, at least one subcontroller 125, or at least one I/O device 120. As used herein, “in communication” includes physical and wireless connections that are indirect through one or more additional components (or over a network) or directly between the two components described as being in communication.

The switch 300 comprises an anomaly detector 305 and a controller 310. An emergency procedures database 315 comprising emergency procedures in read-only memory may be an integral part of the switch (FIG. 3) or may comprise a separate database (FIG. 4). The anomaly detector 305 and controller 310 may comprise one or more processors having application logic or program code.

The anomaly detector 305 may detect at least one anomaly or problem in the ICS system. In specific embodiments, the anomaly detector 305 may detect at least one of: 1) a denial of service attack by monitoring incoming message rate on a network/control line of the independent protection network 205; 2) a denial of service attack by monitoring incoming message rate on the ICS network 210; 3) a loss of the protection network 205 by losing “heartbeat” messages or through pinging; or 4) a loss of ICS network 210 by losing “heartbeat” messages or through pinging. In specific embodiments, the anomaly detector 305 may be signaled by the protection network 205 to perform an emergency suspend, terminate, or hold command.

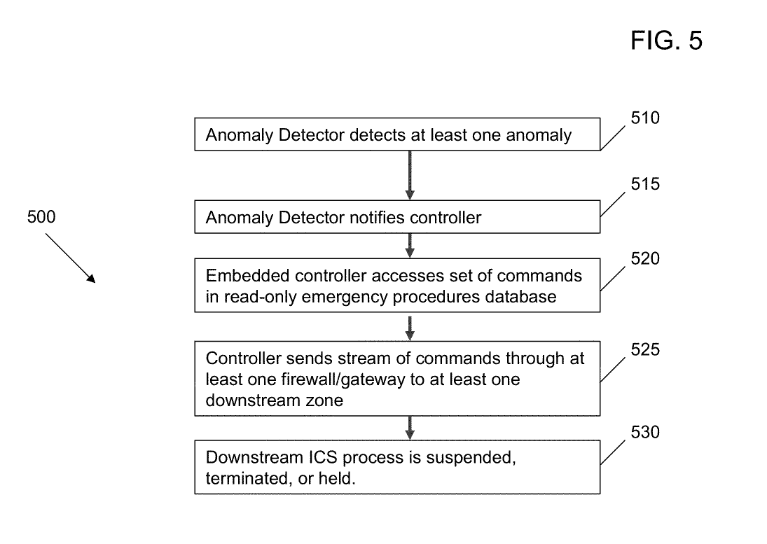

With reference now to FIG. 5, a flowchart showing a method 500 according to an embodiment of the present invention is provided. The anomaly detector detects at least one anomaly in an ICS, 510. Upon detection, the anomaly detector notifies the controller, 515. The controller accesses a set of suspend, terminate, or hold commands in read-only memory emergency procedures database, 520. The controller sends a stream of commands from the emergency procedures database, for example emergency suspend procedures, through at least one ICS firewall/gateway to at least one downstream zone of the ICS, 525. A downstream ICS process is suspended, terminated or placed on hold, 530.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

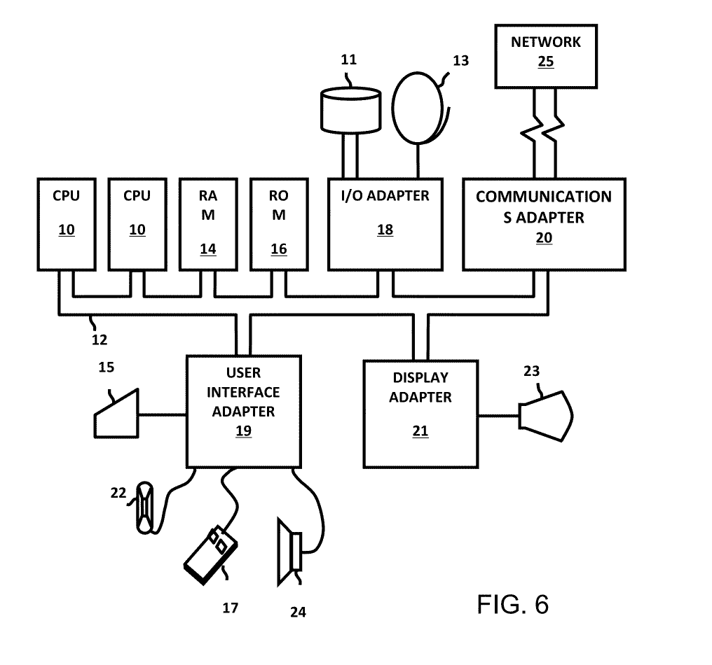

Referring now to FIG. 6, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A system for suspension of processes in an industrial control system, comprising:
the industrial control system network comprising at least one first controller and at least one zone, said at least one zone in communication with at least one input/output device;
a protector comprising at least one firewall; and
a switch in communication with at least one of the at least one first controller, the at least one input/output device, or the at least one firewall,
wherein the switch comprises an anomaly detector, a second controller, and a database comprising emergency procedures having read-only memory.

2. A system according to claim 1, wherein said anomaly detector and said second controller each comprise a processor having embedded application logic or program code.

3. (canceled)

4. A system according to claim 1, wherein said protector network comprises:
a workflow database comprising workflow data;
a response database comprising cure or plan information;
an event analyzer that detects at least one event that triggers a cure or plan action based on event data from at least one firewall; and
a third controller that receives a report from the event analyzer and directs reactions given by the event analyzer to the at least one firewall.

5. A computer program product for suspension of processes in an industrial control system, comprising:
a non-transitory computer readable storage medium;
first program instructions to detect at least one anomaly in an industrial control system network via a switch in communication with at least one firewall, wherein the switch comprises an anomaly detector, a controller, and a database comprising emergency procedures in read-only memory;
second program instructions to notify the controller of the at least one anomaly;
third program instructions for the controller to access the database comprising emergency procedures in read-only memory;
fourth program instructions for the controller to send a stream comprising at least one emergency command through at least one firewall to at least one downstream zone; and
fifth program instructions to suspend or terminate a process in the at least one zone,
wherein said first, second, third, fourth, and fifth program instructions are stored on said non-transitory computer readable storage medium.

6. (canceled)

7. A computer program product according to claim 5, wherein said anomaly detector and said controller each comprise a processor having embedded application logic or program code.

8. A system according to claim 1, wherein the at least one input/output device comprises at least one of a sensor, actuator, circuit, valve, breaker, pump, heater, cooler, regulator, modem, light, conveyor, or computer.

9. A system according to claim 1, wherein the switch is in communication with the at least one input/output device.

10. A system according to claim 1, wherein the switch is in communication with the at least one firewall.

11. A system according to claim 1, wherein the protector network comprises a plurality of firewalls.

12. A system according to claim 1, wherein the protector network is independent of the industrial control system network, being insertable 1) at an entry point of the at least one zone of the industrial control system network, 2) between the at least one zone and a subcontroller of the industrial control system network, or 3) between a subcontroller and input/output devices of the industrial control system network.
